(19) United States
(12) Patent Application Publication
(10) Pub. No.: US 2005/0012885 A1
(43) Pub. Date: Jan. 20, 2005

(54) Field-sequential liquid crystal display panel in which storage capacitors are formed using scan electrode lines

(75) Inventor: Dong-Jin Park, Daegu-si (KR)

Correspondence Address: STAAS & HALSEY LLP, SUITE 700, 1201 NEW YORK AVENUE, N.W., WASHINGTON, DC, 20005, US

(73) Assignee: Samsung SDI Co., Ltd., Suwon-si (KR)

(21) Appl. No.: 10/796,027

(22) Filed: Mar. 10, 2004

(30) Foreign Application Priority Data
Jul. 14, 2003 (KR) 2003-47717

(51) Int. Cl. G02F 1/1343

(52) U.S. Cl. 349/139

(57) ABSTRACT

A field-sequential liquid crystal display panel including thin film transistors, each having a drain, a source, and a gate, cell electrodes respectively coupled to the drains or sources of the thin film transistors, scan electrode lines coupled to the gates of the thin film transistors, data electrode lines coupled to the sources or drains of the thin film transistors, and storage capacitors provided between each of the cell electrodes and a respective one of the scan electrode lines, to sustain voltages applied to the cell electrodes.

### CROSS-REFERENCE TO RELATED APPLICATIONS

This application claims the priority of Korean Patent Application No. 2003-47717, filed on Jul. 14, 2003, in the Korean Intellectual Property Office, the disclosure of which is incorporated herein by reference.

### BACKGROUND OF THE INVENTION

1. Field of the Invention

The present invention relates to a field-sequential liquid crystal display panel, and, more particularly, to a liquid crystal display panel included in a field-sequential liquid crystal display apparatus which operates on a frame-by-frame basis, each frame being made up of fields displaying gray scales.

2. Description of the Related Art

Generally, a field-sequential liquid crystal display apparatus, for example, the apparatus disclosed in Korean Patent Publication No. 2003-27717, filed in 2003, has an illumination device installed below a liquid crystal display panel to sequentially radiate red, green, and blue backlights during each frame. A unit frame is divided into red, green, and blue fields, and in order to drive the liquid crystal, a red backlight is radiated at red cells during a red field, a green backlight is radiated at green cells during a green field, and a blue backlight is radiated at blue cells during a blue field.

Referring to FIG. 1, a conventional field-sequential liquid crystal display apparatus includes a liquid crystal display panel 10, an illumination device 40, a data converter 51, an image memory 52, a buffer 53, a scan driver 54, a data driver 55, an illumination controller 56, and a controller 57.

The controller 57 controls the operations of the data converter 51, the image memory 52, the buffer 53, the scan driver 54, the data driver 55, and the illumination controller 56.

The illumination device 40, which operates under the control of the illumination controller 56, is installed under the liquid crystal display panel 10, and sequentially generates red, green, and blue backlights during each frame.

The data converter 51, which operates under the control of the controller 57, converts received image data into red image data, green image data, and blue image data. The red image data, the green image data, and the blue image data are stored in the image memory 52 in response to a write command signal output from the controller 57. Then, the red image data, the green image data, and the blue image data stored in the image memory 52 are transmitted to the buffer 53 in response to a read-out command signal output from the controller 57. Next, the buffer 53 sends the red image data, the green image data, and the blue image data as serial data to the data driver 55. Thereafter, the data driver 55 sequentially receives serial data of individual colors and processes the serial data to drive data electrode lines of the liquid crystal display panel 10. Finally, the scan driver 54 drives scan electrode lines of the liquid crystal display panel 10 according to a timing control signal output from the controller 57.

FIG. 2 shows a method of driving the field-sequential liquid crystal display panel 10 of FIG. 1. Referring to FIGS. 1 and 2, a unit frame is divided into a red field T_{R}, a green field T_{G}, and a blue field T_{B}. The red field T_{R}, the green field T_{G}, and the blue field T_{B} are made up of scanning times T_{RS}, T_{GS}, and T_{BS}, respectively, and lighting times T_{RL}, T_{GL}, and T_{BL}, respectively. During each of the scanning times T_{RS}, T_{GS}, and T_{BS}, a scanning signal is sequentially applied to first through n-th scan electrode lines LS₁, . . . , and LSₙ, and, at the same time, a data signal is applied to data electrode lines so that liquid crystal cells of the liquid crystal display panel 10 are driven. During each of the lighting times T_{RL}, T_{GL}, and T_{BL}, a backlight of a specific color is emitted from the illumination device 40 and projected onto the liquid crystal cells of the liquid crystal display panel 10.

To drive a color-filter liquid crystal display panel, scan electrode lines are each scanned once during a unit frame while voltages applied to the scan electrode lines are being maintained. Hence, compared to a color-filter liquid crystal display apparatus, the conventional field-sequential liquid crystal display apparatus requires fast scanning and a very-short voltage sustaining time after scanning. If the scanning times T_{RS}, T_{GS}, and T_{BS} are identical with the lighting times T_{RL}, T_{GL}, and T_{BL}, respectively, each of the scan electrode lines LS₁, . . . , and LSₙ of the conventional field-sequential liquid crystal display apparatus requires about ⅓ to ⅙ of the voltage sustaining time required by the color-filter liquid crystal display apparatus. For example, liquid crystal cells coupled to the first scan electrode line LS₁ require about ⅓ of the voltage sustaining time required by the color-filter liquid crystal display apparatus. The liquid crystal cells coupled to the n-th scan electrode line LSₙ require about ⅙ of the voltage sustaining time required by the color-filter liquid crystal display apparatus.

A conventional configuration of the liquid crystal display panel 10 of FIG. 1 will now be described with reference to FIGS. 2 and 3. A drain D and a source S of each thin film transistor 332 of FIG. 3 may be switched with each one another.

Each cell region is made up of one of thin film transistors 332 and one of cell electrodes E_{11R} through E_{31B} Drains D of each of the thin film transistors 332 are respectively connected to the cell electrodes E_{11R} through E_{31B} Gates G of the thin film transistors 332 are respectively connected to scan electrode lines LS₁ through LS₃, which are connected to the scan driver 54. Data electrode lines LD, through LD₃, which are connected to the data driver 55, are connected to sources S of the thin film transistors 332. Storage capacitors C_{11R} through C_{31B}, which sustain voltage after scanning, are respectively coupled between each of the cell electrodes E_{11R} through E_{31B} and corresponding common electrode lines COM.

A process of driving the conventional field-sequential liquid crystal display panel 10 of FIG. 3 during the red field T_{R} of FIG. 2 will now be described.

When a scanning signal with a high voltage is applied to the first scan electrode line LS₁ (that is, in the case of N-channel thin film transistors), thin film transistors coupled to the first scan electrode line LS₁ are turned on, and a red data voltage signal from the data driver 55 is applied to a red cell electrode E_{11R} so that a red liquid crystal cell L_{11R} is driven. Such scanning is sequentially performed on the other scan electrode lines LS₂ through LSₙ during the scanning time T_{RS}.

Voltage sustaining occurs between the ending point of the scanning of each of the scan electrode lines and the starting point of the lighting time T_{RL}. Such voltage sustaining operations are performed by the red storage capacitors C_{11R} through C_{31R}.

During the lighting time T_{RL}, a red backlight from the illumination device 40 is projected onto the liquid crystal display panel 10 through red liquid crystal cells L_{11R} through L_{31R}.

FIG. 4 shows a pattern of a lower substrate of the conventional field-sequential liquid crystal display panel 10 of FIG. 3. FIG. 5 is a cross-section of the thin film transistor included in a cell region in the first row and column of FIG. 4.

Referring to FIGS. 4 and 5, the scan electrode lines LS₁ through LSₙ, including the gates G, are formed on a lower glass substrate 51. An insulative layer 52 is formed on the scan electrode lines LS₁ and LS₂, and a semiconductor layer SE is formed on the insulative layer 52. Drains D and data electrode lines LD, through LD₃, including sources S, are formed on the semiconductor layer SE. Another insulating layer 52 is formed on the data electrode lines LD, through LD₃ and the drains D, and common electrode lines COM are formed on the insulating layer 52 formed on the data electrode lines LD₁ through LD₃ and the drains D. Still another insulating layer 52 is formed on the common electrode lines COM, and a metal contact CT is formed on each of the drains D. The cell electrodes E_{11R} through E_{11B} are formed on the insulating layer 52 formed on the common electrode lines COM. Storage capacitors C_{11R} through C_{21B} are each formed in a space between respective ones of the cell electrodes E_{11R} through E_{21B} and the common electrode lines COM. Since the space between each of the cell electrodes E_{11R} through E_{21B} and each of the common electrode lines COM is narrow, the capacitances of the storage capacitors C_{11R} through C_{21B} are high, as in color-filter liquid crystal display apparatuses. Hence, the conventional field-sequential liquid crystal display apparatus sustains voltage as long as the color-filter liquid crystal display apparatuses.

However, the above-described conventional field-sequential liquid crystal display panel 10 requires only low capacitances which sustain voltage for relatively short times. Hence, the common electrode lines COM formed on the lower glass substrate 51 to form the storage capacitors C_{11R} through C_{31B} are unnecessary. The existence of the common electrode lines COM decreases the numerical aperture of the field-sequential liquid crystal display panel, thus degrading the luminance.

### SUMMARY OF THE INVENTION

The present invention provides a field-sequential liquid crystal display panel with increased luminance by providing each storage capacitor between a cell electrode and a scan electrode line.

Additional aspects and/or advantages of the invention will be set forth in part in the description which follows and, in part, will be obvious from the description, or may be learned by practice of the invention.

According to an aspect of the present invention, there is provided a field-sequential liquid crystal display panel comprising thin film transistors, each comprising a drain, a source, and a gate, cell electrodes respectively coupled to the drains or sources of the thin film transistors, scan electrode lines coupled to the gates of the thin film transistors, data electrode lines coupled to the sources or drains of the thin film transistors, and storage capacitors provided between each of the cell electrodes and a respective one of the scan electrode lines, to sustain voltages applied to the cell electrodes.

As described above, in the field-sequential liquid crystal display panel according to the present invention, each storage capacitor is formed between a cell electrode and a scan electrode line. Hence, the field-sequential liquid crystal display panel according to the present invention does not need extra electrode lines, for example, common electrode lines, to form storage capacitors. Consequently, the field-sequential liquid crystal display panel according to the present invention has an increased numerical aperture and provides an improved luminance.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional field-sequential liquid crystal display apparatus;

FIG. 2 is a timing diagram illustrating a method of driving the field-sequential liquid crystal display panel of FIG. 1;

FIG. 3 is a circuit diagram of the conventional field-sequential liquid crystal display panel of FIG. 1;

FIG. 4 is a top view of a pattern of a lower substrate of the conventional field-sequential liquid crystal display panel of FIG. 3;

FIG. 5 is a cross-section of a thin film transistor included in a cell region in the first column and row of FIG. 4;

FIG. 6 is a circuit diagram of a field-sequential liquid crystal display panel according to an embodiment of the present invention;

FIG. 7 is a circuit diagram of a field-sequential liquid crystal display panel according to another embodiment of the present invention;

FIG. 8 is a top view of a pattern of a lower substrate of the field-sequential liquid crystal display panel of FIG. 7; and

FIG. 9 is a graph showing an example of a necessary capacitance of a storage capacitor versus a voltage sustaining time of each cell electrode in an active matrix liquid crystal display panel.

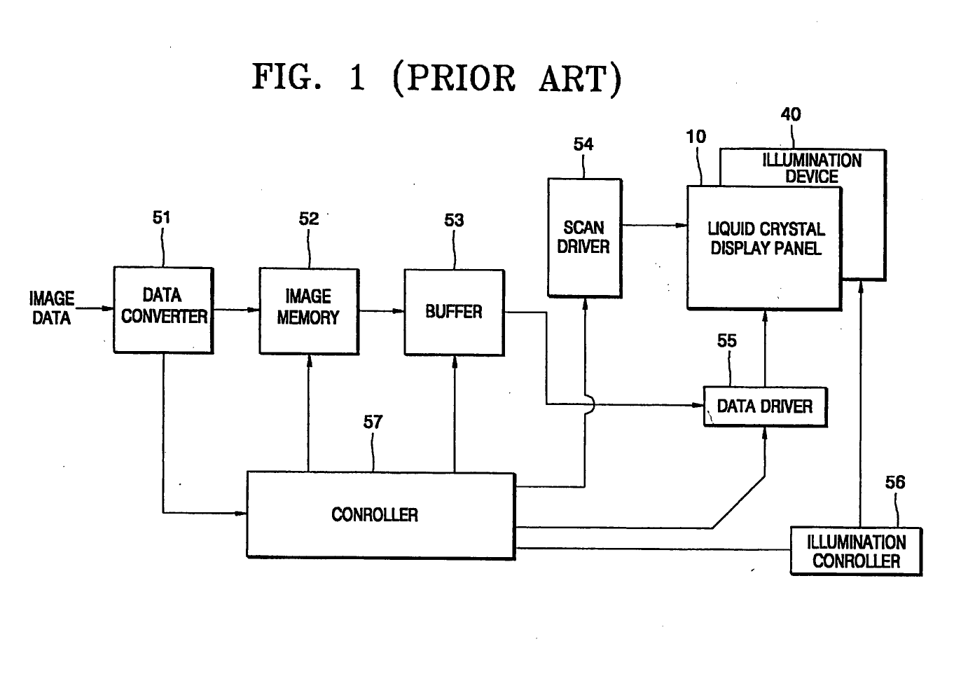

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

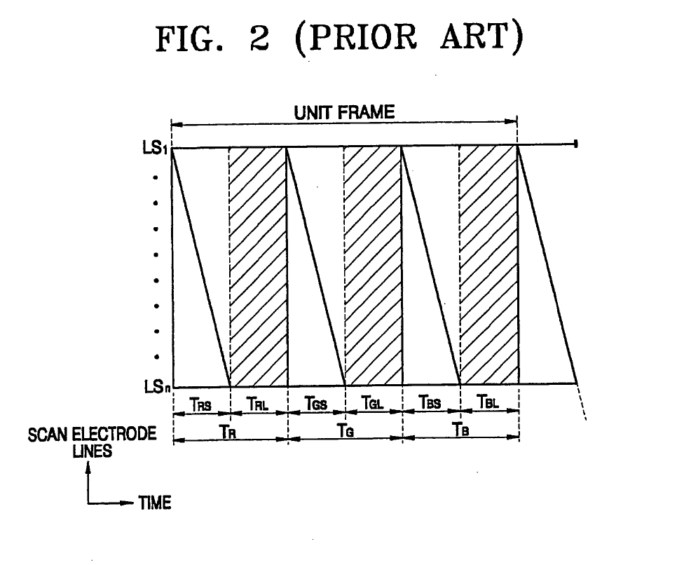

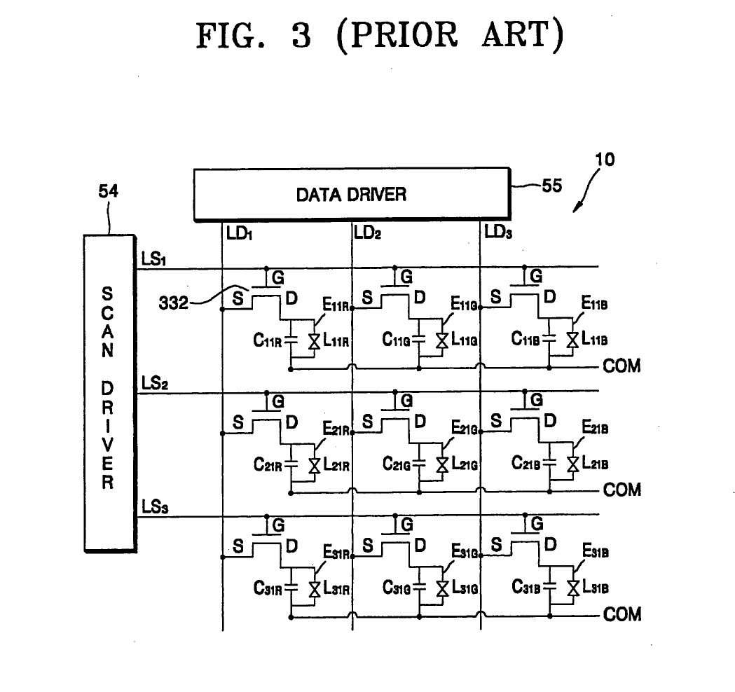

FIG. 6 shows a field-sequential liquid crystal display panel 20 according to an embodiment of the present invention which will now be described with reference to FIGS. 2 and 6. As explained with regard to FIG. 3, a drain D and a source S of each N-channel thin film transistor 332 of FIG. 3 may be switched with one another.

Each of the cell regions in FIG. 6 is made up of an N-channel thin film transistor 332 and one of the cell electrodes E_{11R} through E_{31B}. Drains D of the thin film transistors 332 are respectively connected to the cell electrodes E_{11R} through E_{31B}. Gates G of the thin film transistors 332 are respectively connected to scan electrode lines LS, through LS₃, which are connected to the scan driver 54. Data electrode lines LD₁ through LD₃, which are connected to the data driver 55, are respectively connected to sources S of the thin film transistors 332. Storage capacitors C_{11R} through C_{31B}, which sustain voltage after scanning, are respectively coupled between each of the cell electrodes E_{11R} through E_{31B} and the corresponding scan electrode line LS₁, LS₂, or LS₃.

A process of driving the field-sequential liquid crystal display panel 20 of FIG. 6 during each of the red, green, and blue fields T_{R}, T_{G}, and T_{B} will now be described. First, during the scanning time T_{RS} of the red field T_{R}, when a scanning signal with a high voltage, for example, 18V, is applied to the first scan electrode line LS₁, thin film transistors 332 coupled to the first scan electrode line LS₁ are turned on, and a data voltage signal output from the data driver 55 is applied to a red cell electrode E_{11R} so that a red liquid crystal cell L_{11R} is driven. The data voltage signal has a voltage between 0 and 10 V according to gray scale. A data voltage signal of 5V is applied to a common electrode layer (not shown) of an upper substrate (not shown). An internal configuration of the red liquid crystal cell L_{11R} depends on a voltage applied thereto, that is, a voltage applied between the red cell electrode E_{11R} and the common electrode layer of the upper substrate. Such scanning is sequentially performed on the other scan electrode lines LS₂ through LSₙ during the scanning time T_{RS}.

Voltage sustaining occurs between the ending point of the scanning of each of the scan electrode lines ends and the starting point of the red lighting time T_{RL}. Such voltage sustaining operations are performed by charging the red storage capacitors C_{11R} through C_{31R}. Since a low voltage, for example, −5V, is applied to the scan electrode lines that are not scanned, voltages applied to the red cell electrodes E_{11R} through E_{31R} can be maintained constant although thin film transistors 332 for a red backlight are turned off. Because a field-sequential liquid crystal display panel requires a significantly shorter voltage sustaining time than a color-filter liquid crystal display panel, the short voltage sustaining time can be sufficiently maintained by only the capacities of the storage capacitors C_{11R} through C_{31R} formed between the red cell electrodes E_{11R} through E_{31R} and the scan electrode lines LS₁ through LS₃.

During the red lighting time T_{RL}, a red backlight from the illumination device 40 is projected onto the liquid crystal display panel 20 of FIG. 6 through the red liquid crystal cells L_{11R} through L_{31R}.

Then, during the scanning time T_{GS} of the green field T_{G}, when a scanning signal with a high voltage, for example, 18V, is applied to the first scan electrode line LS₁, the thin film transistors 332 coupled to the first scan electrode line LS₁ are turned on, and a data voltage signal output from the data driver 55 is applied to a green cell electrode E_{11G} so that a green liquid crystal cell L_{11G} is driven. The data voltage signal has a voltage of 0 to 10 V according to gray scale. A data voltage signal of 5V is applied to the common electrode layer (not shown) of the upper substrate (not shown). An internal configuration of the green liquid crystal cell L_{11G} depends on a voltage applied thereto, that is, a voltage applied between the green cell electrode E_{11G} and the common electrode layer of the upper substrate. Such scanning is sequentially performed on the other scan electrode lines LS₂ through LSₙ during the scanning time T_{GS}.

Voltage sustaining occurs between the ending point of the scanning of each of the scan electrode lines ends and the starting point of the green lighting time T_{GL}. Such voltage sustaining operations are performed by charging the green storage capacitors C_{11G} through C_{31G}. Since a low voltage, for example, −5V, is applied to the scan electrode lines that are not scanned, voltages applied to the green cell electrodes E_{11G} through E_{31G} can be maintained constant although thin film transistors 332 for a green backlight are turned off. Because a field-sequential liquid crystal display panel requires significantly shorter voltage sustaining time than a color-filter liquid crystal display panel, the short voltage sustaining time can be sufficiently maintained by only the capacities of the storage capacitors C_{11G} through C_{31G}, which are formed between the green cell electrodes E_{11G} through E_{31G} and the scan electrode lines LS₁ through LS₃.

During the green lighting time T_{GL}, a green backlight from the illumination device 40 is projected onto the liquid crystal display panel 20 through the green liquid crystal cells L_{11G} through L_{31G}.

During the scanning time T_{BS} of the blue field T_{B}, when a scanning signal with a high voltage, for example, 18V, is applied to the first scan electrode line LS₁, the thin film transistors 332 coupled to the first scan electrode line LS₁ are turned on, and a data voltage signal output from the data driver 55 is applied to a blue cell electrode E_{11B} so that a blue liquid crystal cell L_{11B} is driven. The data voltage signal has a voltage of 0 to 10 V according to gray scale. A data voltage signal of 5V is applied to the common electrode layer (not shown) of the upper substrate (not shown). An internal configuration of the blue liquid crystal cell L_{11B} depends on a voltage applied thereto, that is, a voltage applied between the blue cell electrode E_{11B} and the common electrode layer of the upper substrate. Such scanning is sequentially performed on the other scan electrode lines LS₂ through LSₙ during the scanning time T_{BS}.

Voltage sustaining occurs between the ending point of the scanning of each of the scan electrode lines ends and the starting point of the blue lighting time T_{BL}. Such voltage sustaining operations are achieved by charging the blue storage capacitors C_{11B} through C_{31B}. Since a low voltage, for example, −5V, is applied to the scan electrode lines that are not scanned, voltages applied to the blue cell electrodes E_{11B} through E_{31B} can be maintained constant although thin film transistors 332 for a blue backlight are turned off. Because a field-sequential liquid crystal display panel requires significantly shorter voltage sustaining time than a color-filter liquid crystal display panel, the short voltage sustaining time can be sufficiently maintained by only the capacities of the storage capacitors C_{11B} through C_{31B}, which are formed between the blue cell electrodes E_{11B} through E_{31B} and the scan electrode lines LS₁ through LS₃.

During the blue lighting time T_{BL}, a blue backlight from the illumination device 40 is projected onto the liquid crystal display panel 20 through the blue liquid crystal cells L_{11B} through L_{31B}.

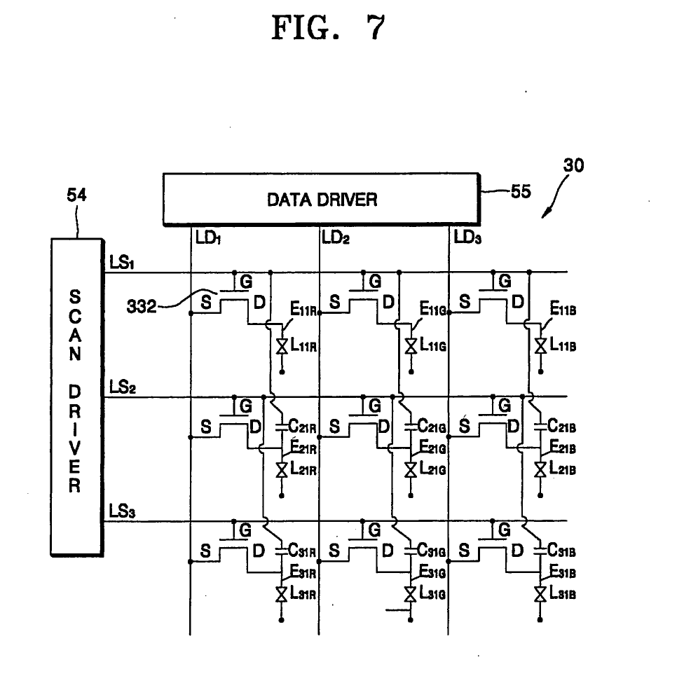

FIG. 7 is a circuit diagram of a field-sequential liquid crystal display panel 30 according to another embodiment of the present invention.

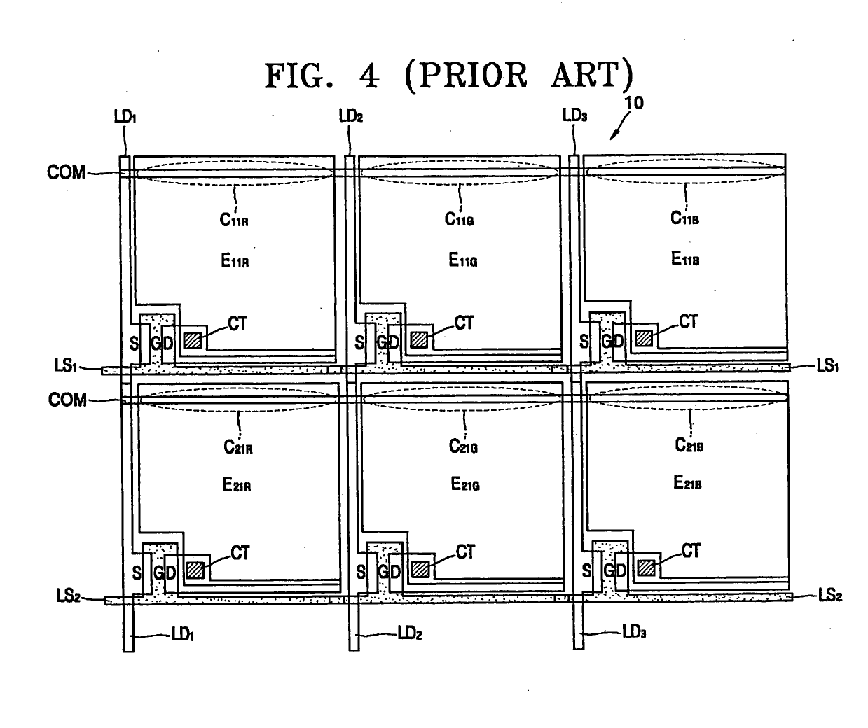

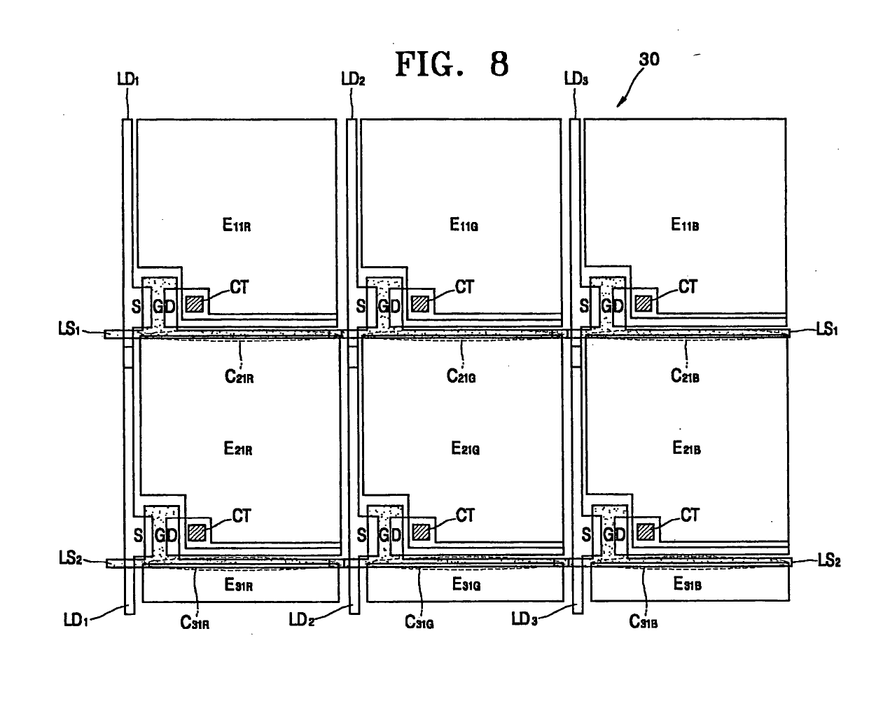

In the field-sequential liquid crystal display panel 20 of FIG. 6, the storage capacitors C_{11R} through C_{31B} are each formed between an i-th (where i is an integer equal to or greater than 1) scan electrode line and respective ones of cell electrodes coupled to the i-th scan electrode line. In the field-sequential liquid crystal display panel 30 of FIG. 7, storage capacitors C_{21R} through C_{31B} are each formed between an i-th scan electrode line and respective ones of cell electrodes coupled to an (i+1)th scan electrode line. This is because, as can be seen by comparing FIGS. 4 and 8, the storage capacitors C_{21R} through C_{31B} can be formed by only extending the upper portions of the cell electrodes E_{21R} through E_{31B} so that they can exist under the scan electrode lines LS₁ and LS₂.

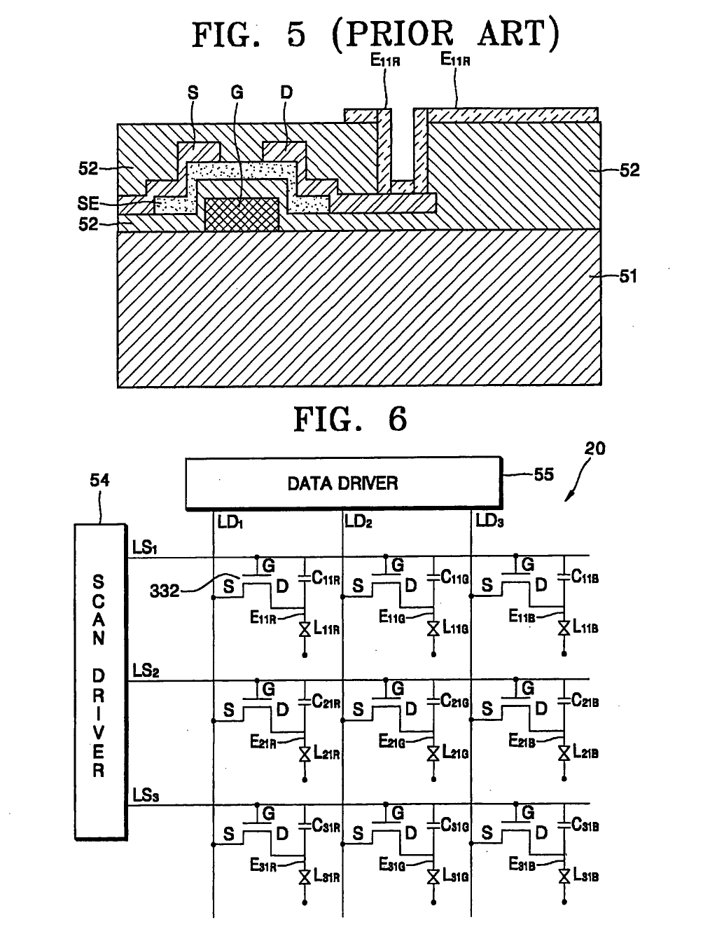

Referring to FIGS. 5 and 8, scan electrode lines LS₁ through LSₙ including gates G are formed on a lower glass substrate 51. An insulating layer 52 is formed on the scan electrode lines LS₁ and LS₂, and a semiconductor layer SE is formed on the insulating layer 52. Drains D and data electrode lines LD₁ through LD₃, including sources S, are formed on the semiconductor layer SE. Another insulating layer 52 is formed on the data electrode lines LD₁ through LD₃ and the drains D, and a metal contact CT is formed on each of the drains D. Cell electrodes E_{11R} through E_{31B} are formed on the insulating layer 52 formed on the data electrode lines LD₁ through LD₃ and the drains D. Storage capacitors C_{21R} through C_{31B} are formed by arranging the cell electrodes E_{21R} through E_{31B} so that their upper portions lie under the scan electrode lines LS₁ and LS₂. Since the interval between each of the cell electrodes E_{11R} through E_{11B} and each of the scan electrode lines LS₁ and LS₂ is long, the capacitances of the storage capacitors C_{21R} through C_{31B} are lower than those of the color-filter liquid crystal display panel. However, since the voltage sustaining time required in a field-sequential liquid crystal display apparatus is shorter than that required in a color-filter liquid crystal display apparatus, the capacitances of the storage capacitors C_{21R} through C_{31B} are sufficient to sustain voltage for the required time.

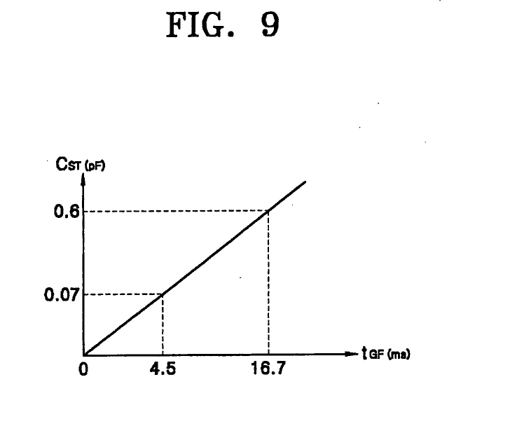

FIG. 9 is a graph showing an example of a necessary capacitance of a storage capacitor versus a voltage sustaining time of a cell electrode in an active matrix liquid crystal display panel. The experiments were performed repeatedly on several active matrix liquid crystal display panels with the same resolution. According to the results of the experiments, a voltage sustaining time in a color-filter liquid crystal display panel was about 16.7 milliseconds (ms), which is the time of a unit frame, and a voltage sustaining time in a field-sequential liquid crystal display panel was on the average of 4.5 milliseconds (ms). The necessary capacitance of each of the storage capacitors of the color-filter liquid crystal display panel was 0.6 pico-Farad (pF), whereas the necessary capacitance of each of the storage capacitors of the field-sequential liquid crystal display panel was 0.07 pF. Thus, without forming extra electrode lines, for example, common electrode lines, on a lower glass substrate, the field-sequential liquid crystal display panel according to the present invention can form storage capacitors by using existing scan electrode lines. According to the results of the experiments, it is suitable that the necessary capacitance of each of the storage capacitors is 0.07 pF to 0.2 pF.

As described above, in the field-sequential liquid crystal display panel according to the present invention, each storage capacitor is formed between a cell electrode and a scan electrode line. Hence, the field-sequential liquid crystal display panel according to the present invention does not need extra electrode lines, for example, common electrode lines, to form storage capacitors. Consequently, the field-sequential liquid crystal display panel according to the present invention has an increased numerical aperture and provides an improved luminance.

Although a few embodiments of the present invention have been shown and described, it would be appreciated by those skilled in the art that changes may be made in these embodiments without departing from the principles and spirit of the invention, the scope of which is defined in the claims and their equivalents.

1. A field-sequential liquid crystal display panel, comprising:
thin film transistors, each comprising a drain, a source, and a gate;
cell electrodes respectively coupled to the drains or sources of the thin film transistors;
scan electrode lines coupled to the gates of the thin film transistors;
data electrode lines coupled to the sources or drains of the thin film transistors; and
storage capacitors provided between each of the cell electrodes and a respective one of the scan electrode lines, to sustain voltages applied to the cell electrodes.

2. The field-sequential liquid crystal display panel of claim 1, wherein the storage capacitors are each provided between one of the cell electrodes and one of the scan electrode lines that is adjacent to a scan electrode line coupled to the respective one cell electrode through one of the thin film transistors.

3. The field-sequential liquid crystal display panel of claim 2, wherein the adjacent scan electrode line and the scan electrode line coupled to the respective one cell electrode are provided at opposite sides of the respective one cell electrode.

4. The field-sequential liquid crystal display panel of claim 1, further comprising a data driver to drive the data electrode lines.

5. The field-sequential liquid crystal display panel of claim 1, wherein the storage capacitors are each provided between one of the cell electrodes and a scan electrode line coupled to the respective one cell electrode through one of the thin film transistors.

6. The field-sequential liquid crystal display panel of claim 1, wherein a capacitance of the storage capacitors is approximately 0.07 pF to 0.2 pF.

7. The field-sequential liquid crystal display panel of claim 1, further comprising a scan driver to drive the scan electrode lines.

8. A field-sequential liquid crystal display panel, comprising:
cell electrodes;
scan electrode lines; and
storage capacitors to sustain voltage applied to the cell electrodes;
wherein the storage capacitors are provided between the cell electrodes and the scan electrode lines.

9. The field-sequential liquid crystal display panel of claim 8, further comprising thin film transistors respectively coupled to each of the cell electrodes, wherein the storage capacitors are each provided between one of the cell electrodes and one of the scan electrode lines that is adjacent to a scan electrode line coupled to the respective one cell electrode through one of the thin film transistors.

10. The field-sequential liquid crystal display panel of claim 8, further comprising thin film transistors respectively coupled to each of the cell electrodes, wherein the storage capacitors are each provided between one of the cell electrodes and a scan electrode line coupled to the respective one cell electrode through one of the thin film transistors.

11. The field-sequential liquid crystal display panel of claim 8, wherein a capacitance of the storage capacitors is approximately 0.07 pF to 0.2 pF.

12. The field-sequential liquid crystal display panel of claim 8, wherein the voltage is sustained in the storage capacitors between an ending point of scanning each of the respective scan electrode lines and a starting point of a lighting time which is applied to ones of the cell electrodes.

13. The field-sequential liquid crystal display panel of claim 8, further comprising a glass substrate, wherein the scan electrode lines are provided on the glass substrate.

14. The field-sequential liquid crystal display panel of claim 13, further comprising:
data electrode lines to drive the cell electrodes; and
an insulating layer provided on the data electrode lines;
wherein the cell electrodes are formed on the insulating layer.

15. The field-sequential liquid crystal display panel of claim 8, wherein the storage capacitors are formed by arranging the cell electrodes so that upper portions of the cell electrodes are disposed under the scan electrode lines.
